(19) United States
(12) Patent Application Publication
(10) Pub. No.: US 2009/0227381 A1
(43) Pub. Date: Sep. 10, 2009

(54) TETHER FOR GAME CONTROLLER

(76) Inventor: Paul Raymond SNAVELY, II, Foster City, CA (US)

Correspondence Address: GLENN PATENT GROUP, 3475 EDISON WAY, SUITE L, MENLO PARK, CA, 94025, US

(21) Appl. No.: 12/042,171

(22) Filed: Mar. 4, 2008

(51) Int. Cl. A63F 13/02

(52) U.S. Cl. 463/47; 273/148 B; 224/267

(57) ABSTRACT

A tether for securing a game controller to a user's wrist includes a retaining band or strap that encircles a portion of the game controller, a wristband, and a link that extends from the elastic band or strap to the wristband. In this way, a motion sensing game controller that does not provide an attachment point for a strap is capable of having a tethering mechanism associated therewith.

### FIELD OF INVENTION

The invention relates to videogames. More particularly, the invention relates to a tether for a videogame controller.

### BACKGROUND OF THE INVENTION

Videogames now allow user interaction through a motion-sensing remote. For example, the Nintendo Wii console includes a motion-sensing remote control referred to as the Wii remote. The Wii remote comes with a wrist strap attached to the bottom, primarily to prevent the remote from slipping from the user's grip during erratic movements. The wrist strap attaches directly to the Wii remote at a built in attachment point.

Other companies offer motion-sensing remotes as well. For example, Sony Corporation offers a SIXAXIS™ remote controller for its PLAYSTATION®3 game console. Unfortunately, such other videogame remote controls do not include attachment points to which a strap may be attached to secure the remote to the user's wrist during game play.

It would be advantageous to provide a technique for retrofitting a tether to a game controller.

### SUMMARY OF THE INVENTION

An embodiment of the invention provides a method and apparatus for tethering a game controller to a user's wrist to secure the game controller to a game player during game play. In one embodiment, a retaining band or strap is provided that encircles a portion of the game controller. For example, an elastic band or a Velcro strap is provided that wraps around a portion of the game controller. A link extends from the elastic band or strap to a wristband, which may comprise an elastic band or a Velcro snap as well. In this way, a motion sensing game controller that does not provide an attachment point for a strap is capable of having a tethering mechanism associated therewith through the expedient of the retrofittable mechanism.

### BRIEF DESCRIPTION OF THE DRAWINGS

The teachings of the present invention can be readily understood by considering the following detailed description in conjunction with the accompanying drawings, in which:

FIG. 1 is a plan view of a tether for a game controller according to the invention;

FIG. 2 is a plan view of a tether for a game controller according to the invention showing the tether attached to a game control and to a user's wrist.

### DESCRIPTION OF THE SPECIFIC EMBODIMENTS

Although the following detailed description contains many specific details for the purposes of illustration, anyone of ordinary skill in the art will appreciate that many variations and alternations to the following details are within the scope of the invention. Accordingly, the exemplary embodiments of the invention described below are set forth without any loss of generality to, and without imposing limitations upon, the claimed invention.

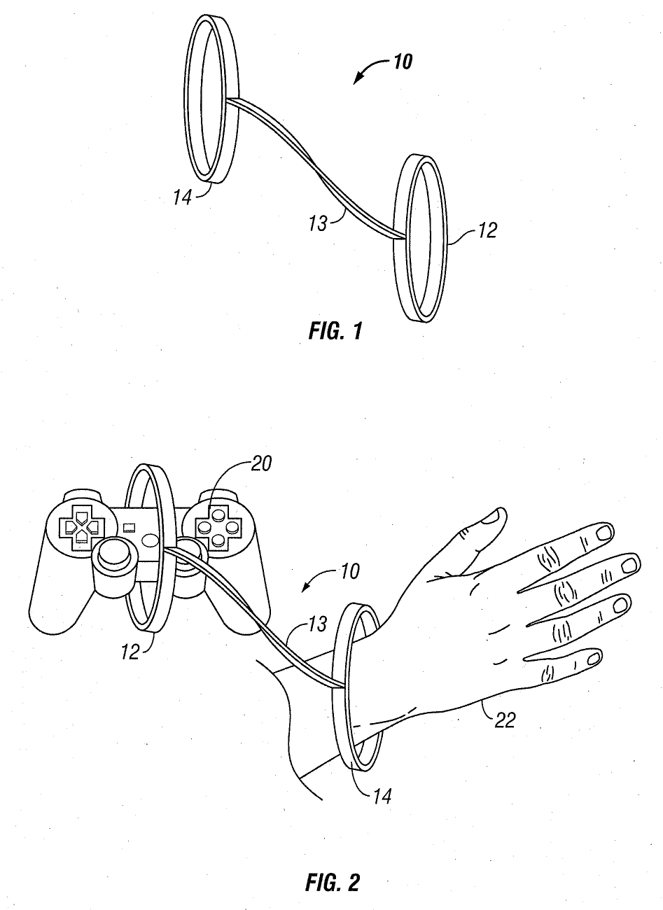

FIG. 1 is a plan view of a tether for a game controller according to the invention. In FIG. 1, the tether (10) is showed to comprises a member (12) for securely encircling a portion of a game controller and a wrist attachment mechanism (14), each of which are connected by a linking portion (13). For purposes of the discussion herein, it will be appreciated that the encircling member for the game controller may be an elastic member, such as a rubber band, it may be a locking tab mechanism such as a tie tab, or it may comprise a strap, such as a Velcro, vinyl, or leather strap. Key to the invention is the provision of an encircling member that securely attaches to the game controller, such as it is not readily dislodged therefrom during aggressive game play. An embodiment provides a member that encircles a narrower portion of the game controller, where broader portions of the game controller prevent the member from slipping therefrom (see FIG. 2). Other embodiments are contemplated for game controllers having different shapes. Further, it is important that the encircling member not interfere with the player's operation of the game controller buttons, etc. Thus, an embodiment provides a narrow, elastic band, such as a rubber band, for encircling the game controller. Other embodiments may require more than one encircling member.

The wrist attachment mechanism may be likewise, for example, comprise a Velcro strap, a leather strap, or an elastic band. An embodiment may also comprise a glove.

The link between the game controller and the user's wrist may be a linkage comprised of, for example, pieces of rope or string, an elastic material, a strip of material, such as cloth, leather, or vinyl, a cable, a chain, or other such material. Additionally, the link may be adjustable in length such that the spacing between the controller and the user's wrist may be varied, for example, to accommodate users of different bodily proportions or for use in different types of game play. Likewise, both the encircling member and the wrist attachment mechanism may be adjustable.

FIG. 2 is a plan diagram showing the tether for a remote control device (20) in which the tether mechanism (10) is provided to secure those remote controls which do not contemplate the use of a tether to the wrist (22) of a user. Unlike the prior art game controllers discussed above, which have a built in attachment point for a strap, the invention herein is intended to address those controllers that do not have this provision. As such, it provides a useful and beneficial expedient.

While the above is a complete description of the preferred embodiment of the present invention, it is possible to use various alternatives, modifications, and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A,” or “An” refers to a quantity of one or more of the item following the article, except where expressly stated otherwise. The appended claims are not to be interpreted as including means-plus-function limitations, unless such limitation is explicitly recited in the given claim using the phrase “means for.”

What is claimed is:

1. A tether for a game controller, comprising:
at least one game controller attachment member for securely encircling at least a portion of a game controller to provide a tether attachment location for a game controller that does not itself have a tether attachment location;
a user attachment mechanism that provides an attachment point at or near a user's wrist and/or hand; and
a link attached between said game controller attachment member and said user attachment mechanism;
wherein said game controller is securely tethered to said user during aggressive game play, and is extensible therefrom substantially along the length of said link.

2. The tether of claim 1, said game controller attachment member comprising any of:
an elastic band, a locking tab mechanism, and a strap.

3. The tether of claim 1, said user attachment mechanism comprising any of:
a strap, an elastic band, and a glove.

4. The tether of claim 1, said link comprising any of:
a rope, a string, an elastic band, a strip, a cable, and a chain.

5. The tether of claim 1, wherein any of said game controller attachment member, said user attachment mechanism, and said link are adjustable.
